(19) United States
(12) Patent Application Publication
(10) Pub. No.: US 2025/0161918 A1
(43) Pub. Date: May 22, 2025

(54) STABILISED ZINC OXIDE MATERIALS

(71) Applicant: JOHNSON MATTHEY PUBLIC LIMITED COMPANY, London (GB)

(72) Inventors: Monica GARCIA, Billingham Cleveland (GB); Pauline Elizabeth GLEN, Billingham Cleveland (GB); Norman MACLEOD, Billingham Cleveland (GB); Michael Thomas NICHOLSON, Billingham Cleveland (GB)

(21) Appl. No.: 18/839,248

(22) PCT Filed: Mar. 31, 2023
(86) PCT No.: PCT/GB2023/050856

§ 371 Date: Aug. 16, 2024

(30) Foreign Application Priority Data
Apr. 29, 2022 (GB) 2206338.2

(51) Int. Cl. B01J 23/06; B01D 53/02; B01J 20/06; B01J 20/10; B01J 20/28; B01J 20/30; B01J 35/56; B01J 35/61; B01J 37/00; B01J 37/02; B01J 37/03; B01J 37/06; B01J 37/08; C02F 1/28; C02F 101/10; C02F 101/20

(52) U.S. Cl. CPC B01J 23/06; B01D 53/02; B01J 20/06; B01J 20/10; B01J 20/28042; B01J 20/28059; B01J 20/3035; B01J 20/3071; B01J 20/3078; B01J 20/3085; B01J 35/56; B01J 35/613; B01J 37/0027; B01J 37/009; B01J 37/0236; B01J 37/031; B01J 37/06; B01J 37/08; C02F 1/288; B01D 2253/106; B01D 2253/1124; B01D 2253/25; B01D 2253/342; B01D 2257/602; C02F 1/281; C02F 2101/103; C02F 2101/20

(57) ABSTRACT

A silicon-modified zinc oxide material, wherein the silicon-modified zinc oxide material (i) has a BET surface area of at least 50 m²/g, (ii) has a Si:Zn atomic ratio in the range of 0.001 to 0.5:1 and (iii) is in the form of a shaped unit selected from a pellet, extrudate or granule, or a wash-coat on a monolith support. The silicon-modified zinc oxide material has improved resistance to thermal sintering and may be used as a catalyst or sorbent material.

This invention relates to stabilised zinc oxide materials, in particular silicon-modified zinc oxide materials useful in catalysts or absorbents.

Zinc oxides are useful catalyst materials and have been used in methanol synthesis and Fischer-Tropsch catalysts as support materials for the catalytically active metals, which are typically copper or cobalt, respectively. EP0261867 A1 discloses the use of zinc silicate catalysts for methanol dehydrogenation. Zinc oxides have also been used as absorbent materials for the removal of hydrogen sulphide from natural gas and refinery hydrocarbons. In these uses, the surface area of the zinc oxides has been found to be an important factor in their effectiveness. However, these materials in use can suffer from thermal sintering by which zinc oxide crystallites coalesce thereby reducing their surface area, which impacts on the performance of the material.

The Applicants have surprisingly found that silicon-modified zinc oxide materials prepared by precipitation have improved thermal stability.

Accordingly, the invention provides a silicon-modified zinc oxide material suitable for use in a catalyst or sorbent material, wherein the silicon-modified zinc oxide material (i) has a BET surface area of at least 50 m²/g, (ii) has a Si:Zn atomic ratio in the range of 0.001 to 0.5:1 and (iii) is in the form of a shaped unit selected from a pellet, extrudate or granule, or a wash-coat on a monolith support.

The invention further provides a catalyst or sorbent material comprising the silicon-modified zinc oxide material, methods of making the silicon-modified zinc oxide material and catalyst or sorbent materials, and processes using the catalyst or sorbent material.

Silicon-doped zinc oxide materials are known for use in preparing transparent conductive thin films. For example, such materials are described in Darr, J. A. et al. Si-doped zinc oxide transparent conducting oxides; nanoparticle optimisation, scale-up and thin film deposition, J. Mater. Chem. C, (2017), 5, 8796, Potter, D. B. et al. Transparent conducting oxide thin films of Si doped ZnO prepared by aerosol assisted CVD. RSC Adv. 7 (2017) and in Luo, J. T. et al. The electrical, optical and magnetic properties of Si doped ZnO films. Appl. Surf. Sci. 258, 2177 2181 (2012). In such materials the silicon is included to increase the relative charge carrier density in the material, with the dopant level carefully controlled to optimise conductivity. The materials are used as transparent thin films and consequently the thermal stability and surface area of the materials is not a significant factor. Furthermore, the present invention provides a catalyst or sorbent in a shaped particulate form, which is not transparent, and in which the conduction properties are irrelevant.

The advantages that the increased stability provides include improved catalyst or sorbent stability, longer catalyst or sorbent life, reduced catalyst or sorbent volumes and the potential for improved process efficiency.

By “sorbent” we include adsorbent and absorbent.

The zinc oxide material that is modified with the silicon may be any mixed oxide of zinc and silicon. The silicon may be present as a mixed oxide with the zinc oxide but preferably the silicon is incorporated into the zinc oxide lattice. The Si:Zn atomic ratio is in the range of 0.001 to 0.5:1 but preferably is in the range 0.01 to 0.1:1. The Si content, of the silicon-modified zinc oxide material expressed as SiO₂ may be up to about 10% by weight. Suitably stabilised zinc oxide materials may have Si:Zn atomic ratio, of 0.019:1, 0.021, 0.037, 0.044:1 or 0.083:1.

The silicon-modified zinc oxide may consist of just oxides of Si and Zn. However other oxides may, if desired, be present to adapt the physical properties of the catalyst or sorbent material. For example, alumina, which may be present in hydrated form, may be present in amounts up to about 20% by weight of the material.

The metal oxide contents in the materials are suitably determined on a loss-free basis, to remove variability caused by differences in the amount of residual carbonate compounds and moisture. A particularly suitable method for determining the silicon oxide content on a loss-free basis is to heat the material to 900° C. for 2 hours in air to remove volatiles before measuring the oxide contents. The silicon content of the materials may be determined using any suitable elemental analysis technique, such as X-ray fluorescence spectroscopy (XRF) using known techniques.

The silicon-modified zinc oxide material is in the form of a shaped unit selected from a pellet, extrudate, or granule, or the silicon-modified zinc oxide may be applied as a wash-coat on a monolith support.

The pellets, extrudates or granules preferably have a length and width in the range 1 to 25 mm, with an aspect ratio (longest dimension divided by shortest dimension)≤4. Pellets and extrudates may usefully have two or more flutes, grooves or lobes around their periphery to improve geometric surface area and reduce pressure drop when used as a fixed bed of shaped units in a catalyst or sorbent vessel. In addition, pellets may have one or more through-holes to further improve the geometric surface area and reduce pressure drop.

Monolith supports are extruded shapes or structures that comprise a plurality of parallel channels. A monolith may contain tens, hundreds or even thousands of parallel channels or through-holes, which are defined and separated by thin walls, such as in a honeycomb structure. The channels can be square, hexagonal, round, or other shapes. The hole density may be from 30 to 200 per cm², and the separating walls can be 0.05 to 1.0 mm thick. Monoliths may have a width or cross-section in the range 10 to 100 cm and a length in the range of 10 to 100 cm. In contrast to the pellets, granules and extrudates that find use in randomly packed fixed beds through which a process fluid passes, monoliths are disposed in containers such that the process fluid is directed through the channels. The open spaces in the cross-sectional area may be 70 to 87% of the frontal area, so resistance to the flow of gases through the holes is low, which minimizes energy consumed forcing gases through the structure. The silicon-modified zinc oxide is applied as a coating on the surfaces of the monolith support.

The different shaping methods have an effect on the surface area, porosity and pore structure within the shaped articles and in turn this often has an effect on the sorption characteristics and on the bulk density. Thus, beds of shaped units in the form of moulded pellets may exhibit a relatively broad absorption front, whereas beds of granulated agglomerates can have a much sharper absorption front: this enables a closer approach to be made to the theoretical absorption capacity. On the other hand, agglomerates generally have lower bulk densities than pelleted or extruded compositions.

The shaped units are preferably pellets because this provides the ability to prepare high strength materials. The silicon-modified zinc oxide may therefore be subjected to pelleting, optionally after pre-compacting the powder, which can improve the pelleting process. The pellet may suitably be a cylindrical pellet. Cylindrical pellets may have a diameter in the range of 2.5 to 10 mm, preferably 3-10 mm and an aspect ratio (length/diameter) in the range of 0.5 to 2.0. Alternatively, the shaped unit may be in the form of rings. In a particularly suitable embodiment, the shaped unit is in the form of a cylinder having two or more, preferably 3 to 7 grooves running along its length.

Pellets, particularly cylindrical pellets with flat or domed ends, are desirably made with pellet densities in the range of 1.8 to 2.4 g/cm³, preferably 1.9 to 2.3 g/cm³. The pellet density may readily be determined by calculating the volume from the pellet dimensions and measuring its weight. As the density is increased, the interstitial volume in the shaped units is reduced, which in turn reduces the permeability of reacting gases. Therefore, for densities >2.4 g/cm³ the reactivity may be less than optimal. For densities <1.8 g/cm³ the crush strengths may be insufficient for long-term use.

The BET surface area of the silicon-modified zinc oxide material is at least 50 m²/g, and is preferably ≥55 m²/g more preferably ≥60 m²/g, most preferably ≥65 m²/g. BET surface areas up to about 130 m²/g may be achieved. BET surface areas are determined by nitrogen physisorption using established methods such as ASTM Method D 3663-03. The BET surface areas are suitably determined on a crushed pellet. The BET surface areas on un-shaped powders are higher, and may be in the range 60 to 150 m²/g. Such very high BET surface areas are believed to arise in part as a consequence of the preparation method and provide a stable support for highly dispersed catalysts and high-capacity sorbents.

The silicon modified zinc oxides may have one or more ²⁹Si solid state nuclear magnetic resonance (SSNMR) signals in the range of −60 ppm to −80 ppm, referenced against kaolinite at −91.2 ppm.

The silicon modified zinc oxide may have a crystallite size, as determined by XRD, of 10 nm or less, preferably 8 nm or less.

The silicon-modified zinc oxides may be produced by precipitation of soluble zinc precursors using a precipitation method. The invention therefore includes a method for making the silicon-modified zinc oxide material comprising the steps of:
(i) forming, in an aqueous medium, an intimate mixture comprising a precipitate of zinc compounds and silica, wherein the silica is provided by a soluble silicate or a colloidal silica,
(ii) recovering, washing and drying the intimate mixture to form a dried composition, and
(iii) forming a shaped unit by calcining and shaping the dried composition by pelleting, extruding or granulating, or by applying the dried composition or calcined composition as a wash coat to a monolithic support.

The soluble zinc precursors may be any suitably soluble zinc salt, but is preferably a zinc nitrate, so that the by-products of precipitation may be readily removed by calcination.

The silicon may be derived either from a silica sol, or from a water-soluble silicon compound, such as an alkali metal silicate, e.g. potassium silicate. Organo-silicates, including alkyl-silicates such as tetramethyl-orthosilicate and tetraethyl-orthosilicate may also be used. The silica stabilises the zinc oxide crystallites during use against thermal sintering and thereby improves the long-term activity of the zinc oxide in the catalyst or sorbent compared to catalyst or sorbents without silica.

The precipitate may be prepared by mixing an acidic aqueous solution containing one or more soluble zinc compounds with an aqueous alkaline precipitant solution. The alkaline precipitant may be an alkali-metal carbonate, an alkali metal hydroxide or a mixture thereof. The alkaline precipitant preferably comprises an alkali metal carbonate. Potassium or sodium precipitants may be used but potassium precipitants are preferred as it is more readily removed by washing than sodium from the precipitated composition. The reaction of the alkaline precipitant with the zinc compounds in the acidic solution causes the precipitation of a zinc-containing precipitate. The precipitation may be performed at temperatures in the range of 10 to 80° C., but is 5 preferably performed at elevated temperature, i.e. in the range 40 to 80° C., more preferably 50 to 80° C., especially 60 to 80° C., as this has been found to produce small crystallites that, after calcination, provide higher surface areas.

The acidic and alkaline solutions may be added one to another in a precipitation vessel but are preferably added simultaneously to the precipitation vessel such that the pH in the precipitation vessel is maintained between 6 and 9, preferably between 6 and 8 after which the resulting co-precipitate slurry is aged, preferably in a separate ageing vessel, at a temperature in the range of 10 to 80° C., preferably in the range of 40 to 80° C., more preferably 50 to 80° C., especially 60 to 80° C., to form crystalline hydroxycarbonate compounds of zinc. Ageing of the precipitate slurry may be carried out in a batch or semi-continuous procedure whereby the aqueous slurry of the precipitated material is held in one or more stirred vessels for selected periods of time. Suspension of the precipitate in the liquid can be by mere stirring, the vigour of stirring depending on the tendency of the particles to settle and the viscosity. Alternatively, the precipitate slurry may be aged in a pulse-flow reactor as described in WO2008/047166, which is herein incorporated by reference. The reaction and after-treatment conditions of the co-precipitate slurry can be chosen to produce definite crystalline compounds for example of the Zincite (ZnO) or Willemite (Zn₂SiO₄) type, which may be determined by X-ray diffraction (XRD).

If a silica sol is used as the source of silica, it may be added to the acidic metal solution and/or added to the precipitation vessel and/or the ageing vessel. Particularly suitable silica sols comprise aqueous dispersions of colloidally dispersed silica having a particle size in the range of 10-20 nm. The pH of the dispersion may be <7, preferably in the range 2 to 4. The silica concentration in the sol may be 100-400 g/litre. Such sols are available commercially as Nissan Chemicals Snowtex-O and Grace Ludox HSA.

If a water-soluble silicate, such as an alkali metal silicate, is used as the source of silica, it may be added to the alkaline precipitant solution and/or to the precipitation vessel and/or the ageing vessel. Suitable alkali metal silicates are soluble sodium silicates and soluble potassium silicates. Such alkali silicates are commercially available as PQ Corporation Kasil™ 1, PQ Corporation Kasolv™ 16, Zaclon LLC Zacsil™ 18 or Evonik Zeopol™. Where an alkali metal silicate is used as the source of silica, the alkali metal in the alkali metal silicate preferably matches the alkali metal in the precipitant solution as this improves washing, recovery and re-processing of waste solutions at scale. The amount of SiO₂ in the alkali metal silicate solution may be in the range 15-35 wt %.

If an organo-silicate, such as an alkyl-silicate of formula Si(OR)₄, where R=C1-C4 alkyl, is used as the source of silica, because it will hydrolyse when contacted with water, it is preferably added directly to the precipitate once formed in the precipitation and/or ageing vessels.

If desired, an alumina sol may optionally be included in the precipitation. An alumina sol is an aqueous colloidal dispersion of aluminium hydroxide, including boehmite and pseudo boehmite. The pH of the dispersion may suitably be <7, preferably in the range 3 to 4. The alumina sol may suitably be added to the precipitation vessel. The alumina sol may be added to the precipitation vessel separately from the acidic metal solution or alkaline precipitant solution. Alumina sols are available commercially or may be prepared by known methods. The alumina concentration in the sol may be 30 to 200 g/litre. Particularly suitable alumina sols comprise dispersions of colloidally dispersed boehmite having a D50 average particle size in the range of 5 to 200 nm, preferably 5 to 100 nm, more preferably 5-50 nm, when dispersed. Such sols are commercially available.

In addition to the alumina sol, or alternatively, if desired, a soluble aluminium compound, such aluminium nitrate or sodium aluminate, may be added to the precipitation vessel. For example, aluminium nitrate may be included in the acidic aqueous zinc-containing solution, while sodium aluminate may be included the alkaline precipitant solution.

If desired, one or more soluble compounds of metals selected from Fe, Co, K, Cs, Mg, Ti, V, Cr, Mn, Mo or Ni, may be included in the acidic aqueous zinc-containing solution or the alkaline precipitant solution.

After precipitation and aging, the intimate mixture is recovered, e.g. by separation of the mother liquors using known methods such as filtering, decanting or centrifuging, and is washed to remove residual soluble salts.

Washing of the intimate mixture may be performed using conventional equipment such as plate- and frame filter presses, for example by re-slurrying the mixture one or more times in salt-free water, or by dynamic cross-flow filtration using an Artisan thickener or Shiver thickener before recovery. For certain catalysts, such as methanol synthesis catalysts, the alkali metal content of the recovered and dried mixture should desirably be reduced to below 0.2% wt, preferably below 0.1% wt, calculated as the respective alkali metal oxide on the dried material on a loss-free basis, because alkali metal may be detrimental to the performance of catalysts. The recovered intimate mixture is dried to form a dried composition. The drying may comprise heating the damp mixture in discrete stages or continuously over an extended period until the maximum temperature is reached. The drying step may be performed at temperatures in the range of 90 to 150° C., preferably 90 to 130° C. under air or an inert gas using conventional drying equipment such as in an oven, rotary drier, spray drier or similar equipment. If desired, the drying step may be included as the first part of a calcination step.

The dried composition is typically in the form of a powder. The average particle size (as determined by sieve fractions, i.e. the weight-average particle size) may be in the range of 10-1000 μm (microns).

The dried composition may comprise one or more hydroxycarbonates of zinc, silica, and optionally alumina, which may be in a hydrated form.

The dried composition may be calcined and shaped to form the catalyst or sorbent material. The dried composition may be calcined, i.e. heated, to convert the precipitated zinc compounds to zinc oxide prior to shaping or, less preferably, the dried composition may be formed into shaped units before calcination. This latter method is less preferred because the calcination of shaped units generally reduces their strength and makes it more difficult to control pellet density. Accordingly, the calcined product is preferably in the form of a powder, which is then shaped to form the pellet, extrudate or granule.

The calcination may be performed at temperatures in the range of 225 to 450° C. preferably 250 to 400° C., more preferably 275 to 350° C. Lower temperatures provide lower stabilities, whereas higher temperatures may reduce the initial surface area. Calcination may be performed under air or an inert gas such as nitrogen, but air or another free-oxygen-containing gas is preferred.

The pellet, extrudate or granule is formed from a powdered composition. Shaping of the shaped unit may be by pelleting, extruding or granulating. The shaping may therefore comprise the steps of (i) feeding a powdered material, optionally with a pelleting aid such as graphite, aluminium stearate or magnesium stearate, into a pelleting die, (ii) compressing the powder to form a shaped unit. Alternatively, extrudates may be formed by forcing a paste formed from a powdered composition with water and an extrusion aid, through a die followed by cutting the material emerging from the die into short lengths. Alternatively, granules may be formed by mixing a powder composition with a little liquid, such as water, insufficient to form a slurry or paste, and then causing the composition to agglomerate into roughly spherical granules in a granulator. The amount of liquid added will vary depending upon the porosity and wettability of the components but may be 0.1 to 0.5 ml/g of mixture. Aqueous or non-aqueous liquids may be used, but water is preferred. Suitable pelleting, extrusion and granulation apparatus is available commercially.

Alternatively, the dried composition or calcined composition may be applied as a wash coat to a monolithic support. The wash coat may be prepared from the dried or calcined silicon-modified zinc oxide powder using known methods, for example by dispersing the powder in an aqueous medium to form a slurry, then applying the slurry to the monolithic support by dipping or spraying the monolithic support with the slurry to form a coated monolith, followed by drying and optionally calcining the coated monolith.

The silicon-modified zinc oxide may be used as a catalyst support. Accordingly, the invention includes a catalyst comprising the silicon-modified zinc oxide supporting a catalytically active metal or metal compound. The catalytically active metal or metal compound may be impregnated into and/or deposited on the shaped catalyst support. The catalytically active metal may be one or more of Na, K, Mg, Ca, Ba, Al, Ti, V, Cr, Mn, Fe, Co, Ni, Cu, Zn, Y, Zr, Nb, Mo, Ru, Rh, Pd, Ag, Sn, Sb, La, Hf, W, Re, Ir, Pt, Au, Pb, or Ce, or a compound thereof.

The catalyst may be fabricated using established impregnation or deposition methods.

In some embodiments, the catalyst comprises one or more transition metals, such as nickel, copper, cobalt or iron and/or precious metals such as platinum, palladium, rhodium iridium or ruthenium, that have been impregnated into or deposited on the silica-modified zinc oxide.

The transition metal and precious metal content in such catalysts may be up to 85% by weight but is preferably in the range 1-60% by weight.

The catalyst containing the catalytically active metal or metal compounds may be subjected to various treatments such as calcination to form metal oxides, reduction with a hydrogen- and/or carbon monoxide-containing gas stream to reduce the metal oxide to elemental form or sulphidation, e.g. with hydrogen sulphide, to form a metal sulphide, and render them active in use. The post treatment may be carried out ex-situ or in-situ, i.e. before or after installation in the reactor where it is to be used.

The catalyst prepared according to the present invention may be applied to any heterogeneous catalytic process, but is preferably applied to fixed bed processes, more preferably fixed bed processes using gaseous reactants. The catalytic process therefore comprises contacting a reactant mixture, preferably a gaseous reactant mixture, with the catalyst under conditions to effect the catalysed reaction. The catalytic process may be selected from hydroprocessing including hydrodesulphurisation, hydrogenation, steam reforming including pre-reforming, catalytic steam reforming, autothermal reforming and secondary reforming and reforming processes used for the direct reduction of iron, catalytic partial oxidation, water-gas shift including isothermal-shift, sour shift, low-temperature shift, intermediate temperature shift, medium temperature shift and high temperature shift reactions, methanation, hydrocarbon synthesis by the Fischer-Tropsch reaction, methanol synthesis, ammonia synthesis, ammonia oxidation and nitrous oxide decomposition reactions. Preferred gaseous reactants comprise hydrogen, for example synthesis gases comprising hydrogen and one or more of carbon dioxide and carbon monoxide.

The silicon-modified zinc oxide may be used as a sorbent, or as a component of a sorbent, or sorbent precursor. The silicon-modified zinc oxide sorbent may be used to capture sulphur compounds such as hydrogen sulphide from process fluids such as natural gas. The silicon-modified zinc oxide sorbent, optionally treated with alkali metal compounds may be used to capture chloride compounds such as hydrogen chloride from process fluids such as refinery streams. The silicon-modified zinc oxide, after treatment with sulphur compound such as hydrogen sulphide or elemental sulphur, may be used to capture heavy metals such as mercury and arsenic from contaminated gaseous or liquid fluid streams.

In some embodiments, the sorbent may comprise one or more alkali metals, alkaline earth metals or transition metals, such as nickel, copper, cobalt or iron that have been impregnated into or deposited on the silica-modified zinc oxide.

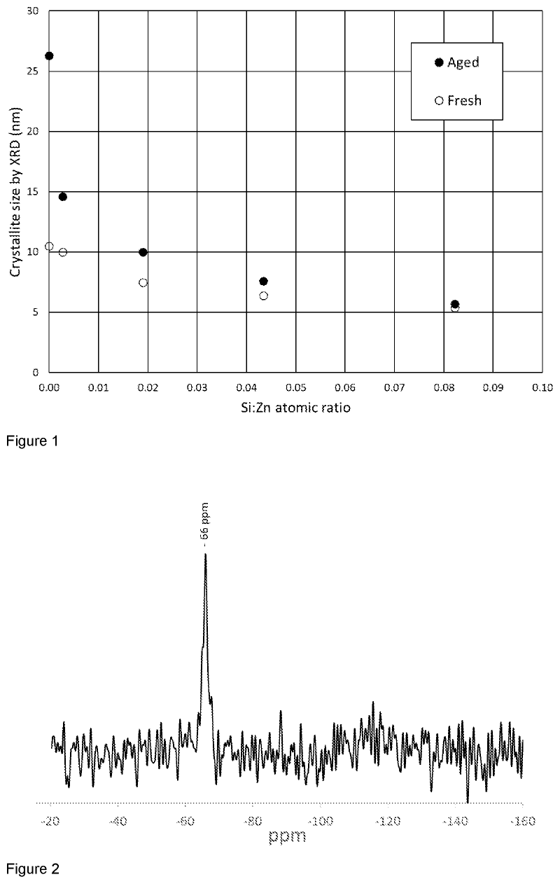

The invention is now further described by reference to the following Examples and by reference to FIG. 1 and FIG. 2.

FIG. 1 is a graph depicting crystallite size of silicon-modified zinc oxide before and after ageing plotted against Si:Zn atomic ratio; and

FIG. 2 is a depiction of ²⁹Si NMR spectrum for a silicon-modified zinc oxide according to the present invention.

In the Examples, XRD was carried out using finely ground samples pressed into an X-Ray transparent sample holder and loaded into a Bruker D8 Advance powder diffractometer. The instrument was operated in a Bragg-Brentano (Reflection) mode using a copper X-Ray tube operating at 40 kV and 40 mA with a 0.2 mm Ni filter to remove CuKβ lines. Diffraction patterns were typically collected over a 10-130° 2θ range with a 0.02° step size and 1 second per step. Phase identification was completed using the Bruker Eva v4.2.1 software and the ICDD PDF4+ structure database. A Pawley fit (Bruker Topas v4.2) was used to calculate a model based around known reflections for the selected phase(s). Crystallite size measurements were based on the integral breadth method assuming isotropic peak broadening.

In the Examples, BET surface areas were determined on the crushed grit (particles of 0.6-1.0 mm), after drying, by nitrogen physisorption using a Micromeritics 2420 ASAP physisorption analyser in accordance with ASTM Method D 3663-03; Standard Test for Surface Area.

Nitrogen was used as the adsorbate and the measurements carried out at liquid nitrogen temperature (77K). The cross-sectional area of a nitrogen molecule was taken as 16.2 Å². Samples were outgassed prior to analysis by purging with dry nitrogen gas for a minimum of 1 hour at an optimal temperature. Five relative pressure/volume data pairs were obtained over the relative pressure region of 0.05 to 0.20 P/Po inclusive. The equilibration time for each point was 10 seconds.

In the Examples, solid state ²⁹Si SSNMR spectra were acquired at a static magnetic field strength of 9.4T (400 MHZ) on a Bruker Advance Neo console using TopSpin 4.0 software. A wide-bore Bruker 4 mm BB/1H WVT MAS probe was used, tuned to 79.51 MHz and referenced to kaolinite at −91.2 ppm. Powdered samples were packed into zirconia MAS rotors with Kel-F caps.

### Example 1: Preparation of a Silicon-Modified Zinc Oxide

A silicon-modified zinc oxide sample with the atomic ratio Si:Zn of 0.004:1 was prepared by precipitation of zinc nitrate solution containing the required amount of a silica sol with a potassium carbonate solution, at a pH of 6.3-6.8 and a temperature between 65-70° C. The resulting precipitate was aged for up to 2 hours at 65-70° C., filtered, washed with demineralised water, dried and calcined in air at 300° C. for 6 hours. The resulting powder was compacted into a pellet, which was subsequently crushed into grit particles suitable for testing.

### Example 2

A silicon-modified zinc oxide sample catalyst with the atomic ratio Si:Zn: 0.019:1 was prepared as described in Example 1.

### Example 3

A silicon-modified zinc oxide sample catalyst with the atomic ratio Si:Zn: 0.044:1 was prepared as described in Example 1.

### Example 4

A silicon-modified zinc oxide sample catalyst with the atomic ratio Si:Zn: 0.083:1 was prepared as described in Example 1.

### Comparative Example 1

A zinc oxide sample was prepared by precipitating a zinc nitrate solution with a potassium carbonate solution, at a pH of 6.3-6.8 and a temperature between 65-70° C. No silicon compounds were included. The resulting precipitate was aged for 2 hours at 65-70° C., filtered, washed with demineralised water, dried and calcined in air at 300° C. for 6 hours. The resulting powder was compacted into a pellet, which was subsequently crushed into grit particles suitable for testing.

### Example 5: Stability Testing

Each of the pelleted materials from Examples 1˜4 and Comparative Example 1 were crushed and sieved to a particle size fraction of 0.6-1.0 mm. Aging experiments used fresh samples loaded into a high-pressure reactor system and treated with a synthesis gas containing stream. These experiments were carried out at 305° C. and 85 bar for 330 hours with a flowing synthesis gas feed with the approximate composition: 77.8 vol % H₂, 3.7 vol % CO, 4.4 vol % CO₂, 2.6 vol % H₂O and 3.2 vol % CH₃OH. Following aging the samples were discharged and characterised using powder X-ray diffraction (XRD), ²⁹Si solid state nuclear magnetic resonance (SSNMR) and BET surface area measurements.

The crystallite size of the various samples, both in the fresh state and following aging, was evaluated using XRD line-broadening analysis, using the method discussed below. The results obtained are set out in Table 1 and displayed in FIG. 1, which shows crystallite size plotted against Si:Zn atomic ratio for both fresh and aged samples. For the un-modified ZnO sample, the crystallite size increased from 10 nm to 26 nm as a result of the aging treatment described. However, with addition of Si, the degree of sintering observed was found to decrease dramatically. Within the range of loadings evaluated, sintering resistance improved with increasing loading, such that at the highest loading tested very little change in crystallite size was observed when comparing fresh and aged samples.

In addition to the crystallite size measurement, surface areas were also measured using the BET method. These results are listed in Table 1, alongside the corresponding XRD data. The surface area measurement again showed a significantly higher resistance to sintering for the Si-modified samples, with the stability improving with increasing loading, in good agreement with XRD data.

The corresponding ²⁹Si SSNMR spectrum for the aged 0.019:1 Si:ZnO sample (Example 2) is shown in FIG. 2. A signal was observed at −66 ppm, consistent with incorporation of Si atoms into the ZnO crystal lattice to form a zinc silicate species.

TABLE 1

| | Si:Zn | XRD | XRD | BET | BET |
|---|---|---|---|---|---|
| | atomic | domain size | domain size | fresh | aged |
| Sample | ratio | fresh (nm) | aged (nm) | (m²/g) | (m²/g) |
| Example 1 | 0.004 | 10.0 | 14.6 | 53 | 27 |
| Example 2 | 0.019 | 7.5 | 10.0 | 70 | 47 |
| Example 3 | 0.044 | 6.4 | 7.6 | 70 | 59 |
| Example 4 | 0.083 | 5.4 | 5.7 | 71 | 62 |
| Comparative | — | 10.3 | 26.2 | 43 | 16 |
| Example 1 * | | | | | |

* Average of two measurements

### Example 6

A silicon-modified zinc oxide sample with the atomic ratio Si:Zn of 0.021:1 was prepared by precipitation of zinc nitrate solution with sodium carbonate solution containing the required amount of sodium silicate, at a pH of 6.3-6.9 and a temperature between 65-70° C. The resulting precipitate was aged for up to 2 hours at 65-70° C., filtered, washed with demineralised water, dried and calcined in air at 300° C. for 6 hours. The resulting powder was compacted into a pellet, which was subsequently crushed into grit particles suitable for testing.

### Example 7

A silicon-modified zinc oxide sample catalyst with the atomic ratio Si:Zn: 0.037:1 was prepared as described in Example 6.

### Example 8: Stability Testing

The pelleted materials from Examples 6 and 7, and Comparative Example 1 were crushed and sieved to a particle size fraction of 0.6-1.0 mm. Aging experiments used fresh samples loaded into a high-pressure reactor system and treated with a synthesis gas containing stream. These experiments were carried out at 220° C. and 27.5 bar for 330 hours with a flowing synthesis gas feed with the approximate composition: 36.7 vol % H₂, 2.6 vol % CO, 10.6 vol % CO₂, 33.3 vol % H₂O and balance N₂. Following aging the samples were discharged and characterised using powder X-ray diffraction (XRD).

The crystallite size of the various samples, both in the fresh state and following aging, was evaluated using XRD line-broadening analysis, using the method discussed above. The results obtained are set out in Table 2. For the un-modified ZnO sample, the crystallite size increased from 10 nm to 23 nm as a result of the aging treatment described. However, with addition of Si, the materials were able to retain much smaller crystallite sizes after the aging treatment. Within the range of loadings evaluated, sintering resistance again improved with increasing loading.

TABLE 2

| | Si:Zn | XRD | XRD |
|---|---|---|---|
| | atomic | domain size | domain size |
| Sample | ratio | fresh (nm) | aged (nm) |
| Example 6 | 0.021 | 5.5 | 10 |
| Example 7 | 0.037 | 4.0 | 7.4 |
| Comparative | — | 10.3 | 22.6 |
| Example 1 | | | |

1. A silicon-modified zinc oxide material suitable for use in a catalyst or sorbent material, wherein the silicon-modified zinc oxide material (i) has a BET surface area of at least 50 m²/g, (ii) has a Si:Zn atomic ratio in the range of 0.001 to 0.5:1 and (iii) is in the form of a shaped unit selected from a pellet, extrudate or granule, or a wash-coat on a monolith support.

2. The silicon-modified zinc oxide material according to claim 1, wherein the Si:Zn atomic ratio is in the range of 0.01 to 0.1:1.

3. A silicon-modified zinc oxide material according to claim 1, wherein the Si content, expressed as SiO₂, is up to 10% by weight.

4. The A-silicon-modified zinc oxide material according to claim 1, wherein the silicon is incorporated into the zinc oxide lattice.

5. A silicon-modified zinc oxide material according to claim 1, further comprising an alumina, or a hydrated alumina in an amount up to 20% by weight of the material.

6. A silicon-modified zinc oxide material according to claim 1, wherein the pellets, extrudates or granules have a length and width each in the range 1 to 25 mm, with an aspect ratio≤4.

7. A silicon-modified zinc oxide material according to claim 1 in the form of a wash-coat on a monolith support, wherein the monolith support has a length and width each in the range 10 to 100 cm.

8. A silicon-modified zinc oxide material according to claim 1, wherein the BET surface area is ≥55 m²/g.

9. A silicon-modified zinc oxide material according to claim 1, having one or more ²⁹Si solid state nuclear magnetic resonance (SSNMR) signals in the range from about −60 ppm to −80 ppm, referenced against kaolinite at −91.2 ppm.

10. A method for making the silicon-modified zinc oxide material according to claim 1, comprising the steps of:
(i) forming, in an aqueous medium, an intimate mixture comprising a precipitate of zinc compounds and silica, wherein the silica is provided by a soluble silicate or a colloidal silica,
(ii) recovering, washing and drying the intimate mixture to form a dried composition, and
(iii) forming a shaped unit by calcining and shaping the dried composition by pelleting, extruding or granulating, or by applying the dried composition or calcined composition as a wash coat to a monolithic support.

11. A method according to claim 10, wherein the precipitate of zinc compounds and silica is prepared by mixing an acidic aqueous solution containing a zinc compound with an aqueous alkaline precipitant solution in a precipitation vessel.

12. A method according to claim 11, wherein the zinc compound is a zinc nitrate and the alkaline precipitant comprises an alkali metal carbonate.

13. A method according to claim 11, wherein the precipitation is performed at a temperature in the range of 40 to 80° C.

14. A method according to claim 11, wherein the precipitate is aged in a separate ageing vessel at a temperature in the range of 10 to 80° C.

15. A method according to claim 10, wherein the silica is derived from a silica sol, or from a water-soluble silicon compound, or from an organo-silicate.

16. A method according to claim 11, wherein a silica sol is added to the acidic aqueous solution and/or added to the precipitation vessel and/or the ageing vessel.

17. A method according to claim 11, wherein an alkali metal silicate is added to the alkaline precipitant solution and/or to the precipitation vessel and/or ageing vessel.

18. A method according to claim 11, wherein an alumina sol or a soluble aluminium compound is added to the precipitation vessel.

19. A method according to claim 10, wherein the drying step is performed at a temperature in the range of 90-150° C.

20. A method according to claim 10, wherein the calcination is performed at a temperature in the range of 225 to 450° C.

21. A method according to claim 10, wherein the calcination is performed before shaping by pelleting, extruding or granulating.

22. A catalyst comprising the silicon-modified zinc oxide according to claim 1 supporting a catalytically active metal or metal compound.

23. A catalytic process using a catalyst according to claim 22.

24. A sorbent or sorbent precursor comprising the silicon-modified zinc oxide according to claim 1.

25. A sorbent process using a sorbent or sorbent precursor according to claim 24 to capture sulphur compounds or chloride compounds from process fluids or capture heavy metals from contaminated gaseous or liquid fluid streams.
